(19) United States
(12) Patent Application Publication
(10) Pub. No.: US 2015/0258678 A1
(43) Pub. Date: Sep. 17, 2015

(54) LIGHTING-BEARING TOOL TRAY KIT

(71) Applicant: YEO-MING WANG, Taipei City (TW)

(72) Inventor: YEO-MING WANG, Taipei City (TW)

(21) Appl. No.: 14/209,285

(22) Filed: Mar. 13, 2014

(51) Int. Cl. B25H 3/06; F21V 33/00; B65D 25/22

(52) U.S. Cl. CPC B25H 3/06; B65D 25/22; F21V 33/0084; F21Y 2101/02

(57) ABSTRACT

A lighting-bearing tool tray kit which has: a tool tray on which a hand tool socket or tool part sockets are designed; at least a lighting device installed on the tool tray and having at least a luminous element. As such, the lighting-bearing tool tray kit illuminates an obscure or dark work environment in which a worker can conveniently access tool parts, featuring good practicability and added values of a product. Moreover, a tool tray of the lighting-bearing tool tray kit can be erected or hung for inspections of tool parts to be accessed, light beams projected in a different direction for good lighting applications, and promotion of product competitiveness.

### BACKGROUND

1. Field of the Invention

The present disclosure presents a tool tray, particularly a lighting-bearing tool tray kit which facilitates access to a tool in an obscure work environment.

2. Descriptions of the Related Art

In general, an ordinary hand tool which is used in different work conditions and those assorted tool parts with different functions and sizes are usually stored in a tool tray. The prior art for technique of a tool tray had been disclosed in Patent No. M362746 and Patent No. M418002. As shown in Patent No. M362746, a tool tray comprises a number of tool sockets, each of which has an elastic arm and several surfaces: the two surfaces adjacent to the elastic arm develop two independent dissected grooves; the elastic arm at its rear end develops a bump; each of the tool sockets in which a tool head is axially inserted depends on the bump to resist the tool head with neither shakes nor gaps occurring.

As shown in Patent No. M418002, a tool tray kit comprises a tool tray and at least an inserted block: the tool tray comprises a plurality of sockets; the inserted block comprises a basic tray and a bump as well as a pricking pin in a socket, both of which are located on two sides of the basic tray. The pricking pin comprises a polygonal stopper at its rear end by which the socket allows a screwdriver head and the pricking pin to pass and be held. With the basic tray contacting the tool tray's surface and the inserted block rotated, the stopper resists the tool tray's bottom under the socket so that a sleeve is held by the bump.

The conventional tool tray which is competent in positioning a tool part (e.g., a tool head in M362746) or allowing another tool part (e.g., a sleeve in M418002) to be inserted provides a limited function for accommodation of tool parts but fails in promotion of work applications, for example, the conventional tool tray used in an obscure work environment or during the blackout is considered as an unideal design because it obstructs access to a tool part and fails in providing extra illumination for a worker. Against this background, how to provide a solution without drawbacks in applications of a conventional tool tray is one issue to be overcome by the persons skilled in the art.

Having considered disadvantages in use and unideal structural design of a conventional tool tray, the inventor designed a lighting-bearing tool tray kit as one solution facilitating access to a tool part and practicability for the general public and development of the industry.

### SUMMARY OF THE INVENTION

The present disclosure presents a lighting-bearing tool tray kit illustrating an obscure or dark work environment in which a worker can conveniently access tool parts and featuring good practicability and added values of a product.

The present disclosure further presents a lighting-bearing tool tray kit with a tool tray which can be erected or hung for inspections of tool parts to be accessed, light beams projected in a different direction for good lighting applications, and promotion of product competitiveness.

For the above purposes, the lighting-bearing tool tray kit features some technical measures as follows: a tool tray on which a hand tool socket and tool part sockets are designed; at least a lighting device which is installed on the tool tray and comprises at least a luminous element.

In the lighting-bearing tool tray kit, the tool tray develops a hanging hole on its back panel.

In the lighting-bearing tool tray kit, the tool tray joins a support component via pivots which is located on the back panel and rotationally detached from or attached to the tool tray.

In the lighting-bearing tool tray kit, the lighting device is a long-shaped component.

In the lighting-bearing tool tray kit, the lighting device is laterally installed on the tool tray.

In the lighting-bearing tool tray kit, the lighting device joins the tool tray via pivots. In the lighting-bearing tool tray kit, the lighting device can be rotated via pivots for a changed lighting direction.

In the lighting-bearing tool tray kit, the lighting device can be separated from the pivots and installed on the tool tray's back panel for a changed lighting direction.

In the lighting-bearing tool tray kit, the luminous elements are made of LEDs and the tool tray is provided with a battery compartment in which batteries or rechargeable batteries are held.

In the lighting-bearing tool tray kit, the lighting device comprises a flexible lamp arm with one end fixed on the tool tray and the other end comprising the luminous elements.

In the lighting-bearing tool tray kit, the tool tray further links a second tool tray on which at least a lighting device and at least a luminous element thereon are installed.

The lighting-bearing tool tray kit features further technical measures as follows: a tool tray on which a hand tool socket or tool part sockets are designed; a second tool tray joining the tool tray via pivots; at least a long-shaped lighting device which is situated on the tool tray and comprises at least a luminous element.

In the lighting-bearing tool tray kit, the second tool tray is provided with at least a lighting device on which at least a luminous element is installed.

In the lighting-bearing tool tray kit, the tool tray joins a support component via pivots on the back panel and the lighting device on the tool tray comprises a flexible lamp arm with one end fixed on the tool tray and the other end comprising the luminous elements.

For technical features and effects in terms of the present disclosure completely comprehended and recognized, the preferred embodiments and accompanying drawings are thoroughly described hereinafter.

### BRIEF DESCRIPTION OF THE DRAWINGS

FIG. 1 is a schematic view illustrating a lighting-bearing tool tray kit in the first embodiment.

FIG. 2 is a first schematic view illustrating a lighting-bearing tool tray kit in service in the first embodiment.

FIG. 3 is a second schematic view illustrating a lighting-bearing tool tray kit in service in the first embodiment.

FIG. 4 is a schematic view illustrating a lighting-bearing tool tray kit in the second embodiment.

FIG. 5 is a schematic view illustrating a lighting-bearing tool tray kit in the third embodiment.

FIG. 6 is a schematic view illustrating a lighting-bearing tool tray kit in the fourth embodiment.

FIG. 7 is a first schematic view which illustrates a lighting device of a lighting-bearing tool tray kit is rotated for light beams projected backward.

FIG. 8 is a second schematic view which illustrates a lighting device of a lighting-bearing tool tray kit is rotated for light beams projected backward.

FIG. 9 is a third schematic view which illustrates a lighting device of a lighting-bearing tool tray kit is rotated for light beams projected backward.

### DETAILED DESCRIPTION OF THE PREFERRED EMBODIMENTS

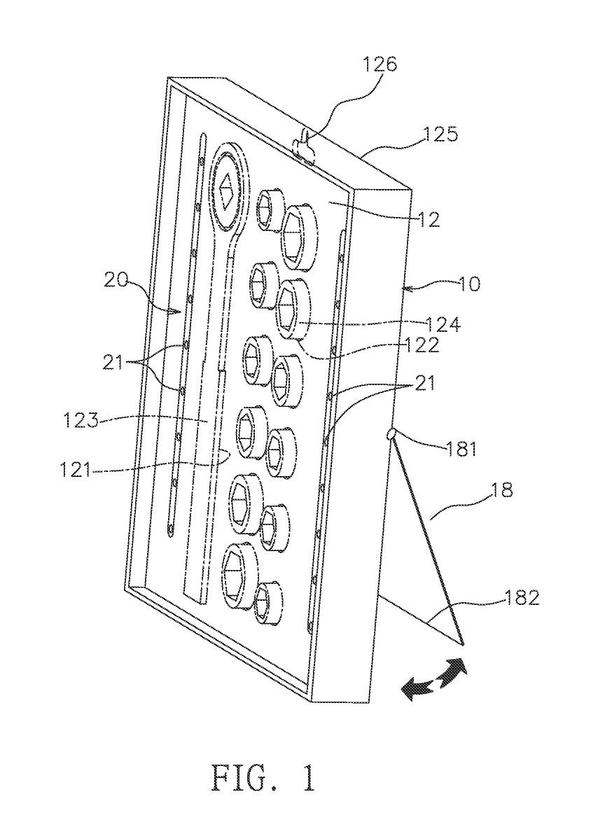

Please refer to FIG. 1 which illustrates a lighting-bearing tool tray kit of the present disclosure in the first embodiment, comprising a tool tray kit 10 and lighting devices 20. The tool tray kit 10 comprises a tool tray 12 with a hand tool socket 121 and tool part sockets 122 prepared on its front: the hand tool socket 121 and the tool part sockets 122 are used to position a hand tool 123 (e.g., wrench, monkey spanner, screwdriver, etc.) and tool parts 124 (e.g., nuts, screws, etc.), respectively; the tool tray 12 has a back panel 125 (a reverse side behind the hand tool socket or the tool part sockets) with a hanging hole 126 opened atop (as shown in the figure/similarly hereinafter); the tool tray 12 is further provided with a support component 18 (a laminar body in the embodiment) which links the lower part of the back panel 125 and comprises a joint end 181 atop and a supporting end 182 underneath: the joint end 181 joining the back panel 125 via pivots allows the support component 18 to be rotationally detached or attached, for example, the support component 18 rotationally detached is positioned by the supporting end 182 so that the tool tray 12 is erected. In other words, the support component 18 directly joins the back panel 125 of the tool tray 12 via pivots or the hanging hole 126 is directly opened on the tool tray 12.

Preferably, the lighting devices 20 installed on the tool tray 12 are long-shaped components which are situated on both sides of the tool tray 12 and comprise a plurality of luminous elements 21, for example, Light Emitting Diode (LED) bulbs for illumination. Moreover, the tool tray 12 is provided with a battery compartment (not shown in the figure) which is preferably designed behind the tool tray 12 for batteries or rechargeable batteries accommodated and supplying power to the lighting devices 20 (luminous elements 21); alternatively, the tool tray 12 is provided with a power connector (not shown in the figure) which is used to link an external power supply. In the embodiment, the lighting devices 20 are installed on both sides of the tool tray 12 or other preferable positions on the tool tray 12.

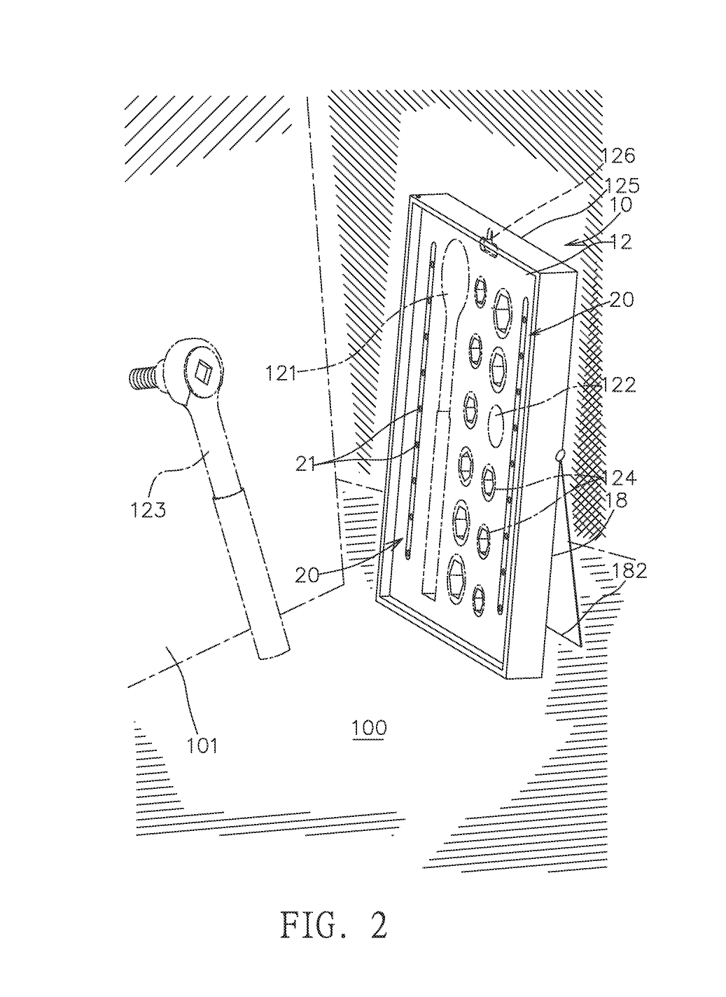

Please refer to FIG. 2 that illustrates the tool tray kit 10 of a lighting-bearing tool tray kit in service is placed in an obscure work environment 100 in which the lighting devices 20 (luminous elements 21) on the tool tray 12 are capable of projecting light beams. For illumination in a workplace and access to the hand tool 123 or tool parts 124, the tool tray 12 is erected on the ground under the work environment 100 in which any task is conducted with the support component 18 rotationally detached and contacting the ground.

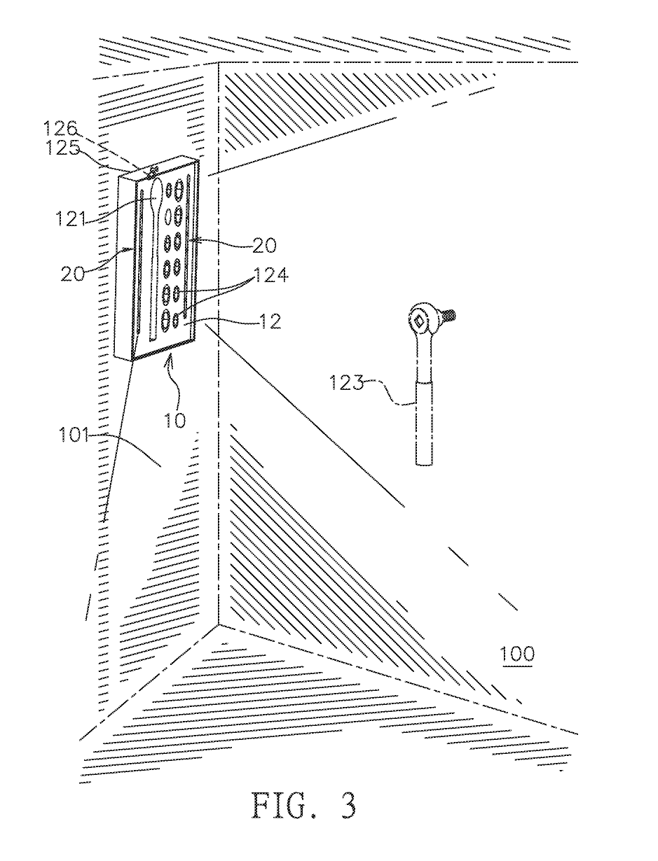

Please refer to FIG. 3 which illustrates a lighting-bearing tool tray kit of the present disclosure is in use. In an obscure work environment 100, the lighting devices 20 (luminous elements 21) on the tool tray 12, which is hung on a wall 101 with the hanging hole 126 penetrated by a peg on the wall 101, illuminates upper space of the work environment 100. As such, the upper space in the work environment 100 is illuminated by the lighting devices 20 (luminous elements 21) for a worker who tries to inspect, take or place a hand tool 123 or tool parts 124.

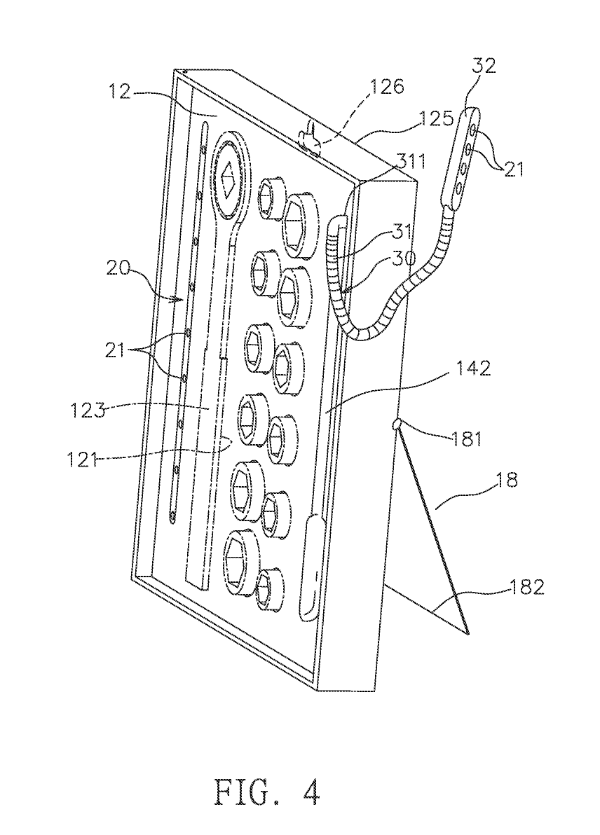

Please refer to FIG. 4 which illustrates a lighting-bearing tool tray kit of the present disclosure in the second embodiment that is based on the first embodiment but different from the first one as shown hereinafter. The tool tray 12 is provided with a lighting device 30 comprising a flexible lamp arm 31 with one end fixed on the tool tray 12 and the other end linking a lighting part 32 on which a plurality of luminous elements 21 such as LEDs for illumination are installed. In a preferred embodiment, the tool tray 12 is provided with a lighting device 20 (as shown in FIG. 1) at one side and a lighting device 30 at the other side featuring a flexible lamp arm 31 which is properly lifted and adjusted for light beams projected in a specific direction (e.g., back side) as is a snake lamp. Alternately, the tool tray 12 is further provided with a groove 142 in which the lighting device 30 is held.

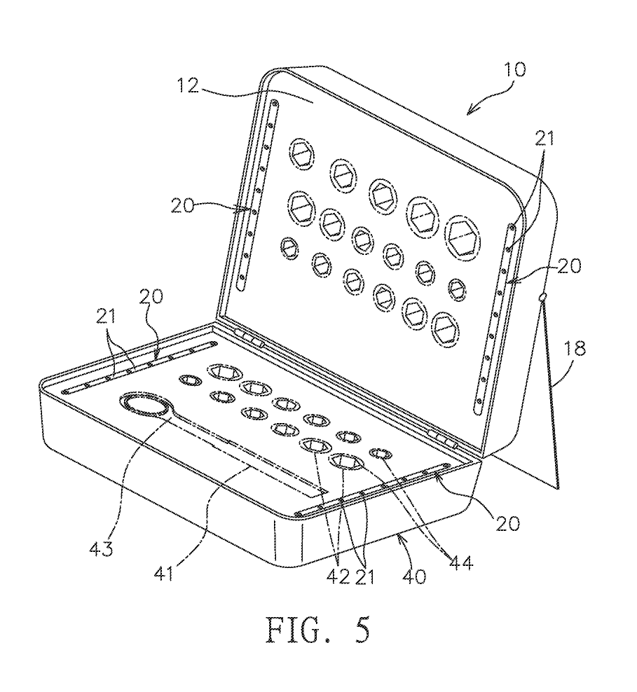

Please refer to FIG. 5 which illustrates a lighting-bearing tool tray kit of the present disclosure in the third embodiment that is based on the first embodiment but different from the first one as shown hereinafter. The tool tray 12 further joins a second tool tray 40 via pivots which is provided with a hand tool socket 41 and tool part sockets 42 thereon as those on the tool tray 12 for accommodation of a hand tool 43 (e.g., wrench, monkey spanner, screwdriver, etc.) and tool parts 44 (e.g., nuts, screws, etc.), respectively. With or without a support component on the reverse side, the second tool tray 40 further comprises lighting devices 20 at both sides. As such, the tool tray 12 which depends on the conjoint second tool tray 40 can be rotationally opened or closed so that the lighting devices 20 on the tool tray 12 and the second tool tray 40 contribute to more illumination projected to a different direction. In the present embodiment, a hanging hole 126 is opened on neither the tool tray 12 nor the second tool tray 40.

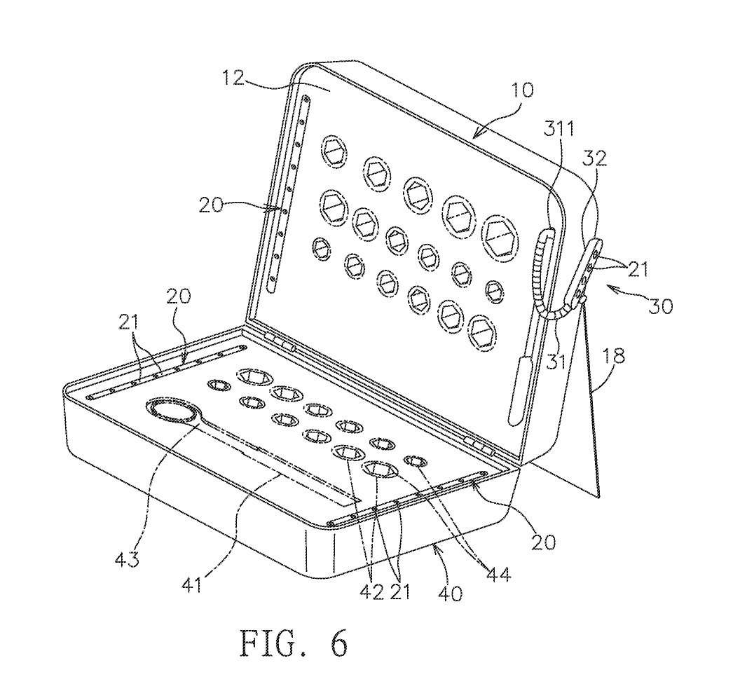

Please refer to FIG. 6 which illustrates a lighting-bearing tool tray kit of the present disclosure in the fourth embodiment that is based on the third embodiment but different from the third one as shown hereinafter. The tool tray 12 in the fourth embodiment is also provided with a fixed lighting device 20 and a movable lighting device 30 that is presented in the second embodiment and comprises same components such as the flexible lamp arm 31, the lighting part 32 and the luminous elements 21 (LEDs), all of which exert functions as a snake lamp.

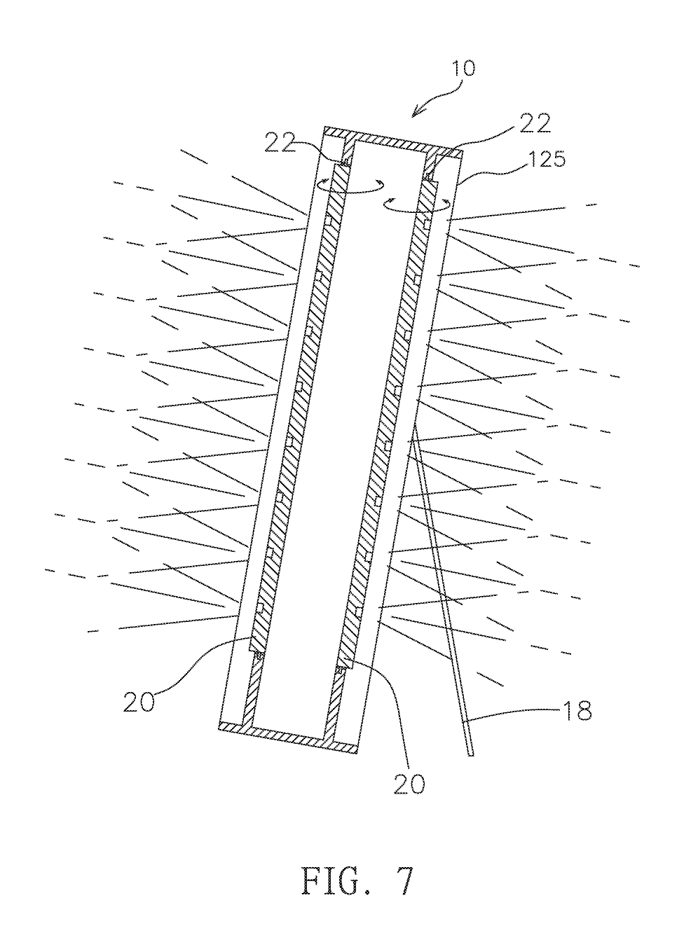

In the above embodiments (as shown in FIG. 1 through FIG. 6), the lighting devices 20 in a lighting-bearing tool tray kit of the present disclosure can be further adjusted. As shown in FIG. 7, each of the lighting devices 20 is laterally installed on the tool tray 12 via pivots 22 and rotated for light beams projected in a different direction, for example, rear side, with the luminous elements 21 on the lighting device 20 facing backward.

In the above embodiments (as shown in FIG. 1 through FIG. 6), the lighting devices 20 in a lighting-bearing tool tray kit of the present disclosure can be further adjusted. As shown in FIG. 7, each of the lighting devices 20 to be separated from the pivots 22 can be flexibly removed from the front of the tool tray 12 and installed on the back panel 125 so that light beams are projected backward from the luminous elements 21 on the lighting device 20.

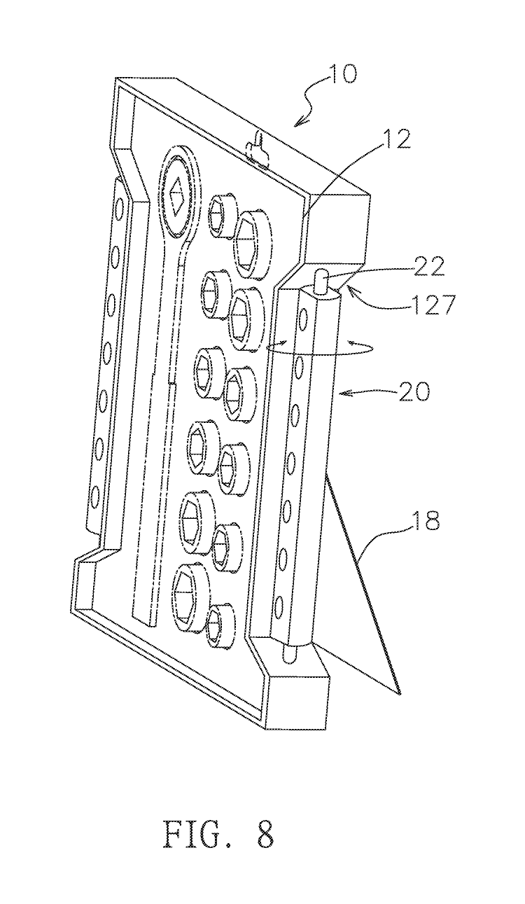

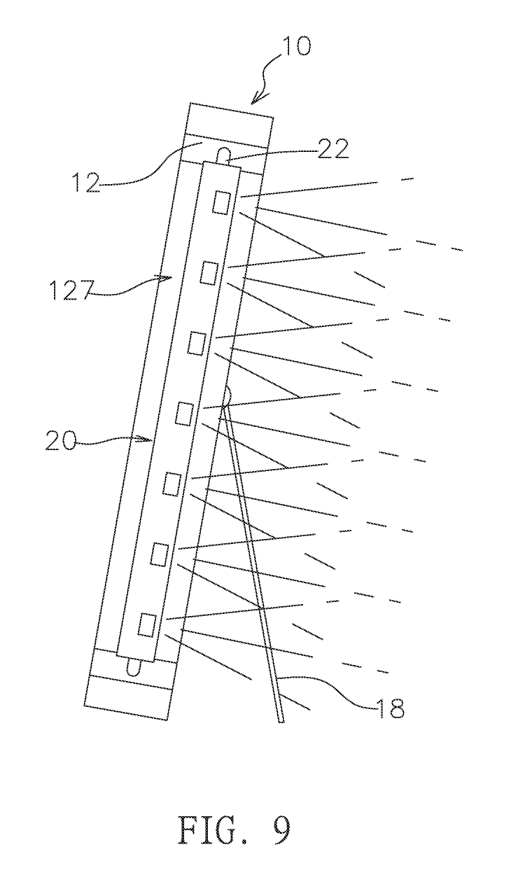

Please refer to FIGS. 8 and 9 which illustrate the lighting devices 20 are rotated for light beams projected in a different direction. Each of the lighting devices 20 is installed on the lateral edge of the tool tray 12, that is, against sunken slots 127 on the lateral edge of the tool tray 12 with both ends of the lighting device 20 through the pivots 22 embedded into the sunken slots 127 by which the lighting device 20 is held and rotated backward so that light beams are projected behind the tool tray 12 for better practical performance.

The lighting-bearing tool tray kit in the present disclosure illuminates an obscure or dark work environment, facilitating access to tool parts and operation for good practicability and added values. Moreover, the tool tray in the present disclosure which is designed to be erected or hung contributes to convenient inspections of tool parts and light beams projected in a different direction for better lighting applications and product competitiveness.

Accordingly, a lighting-bearing tool tray kit in the present disclosure meets patentability. However, the above descriptions are preferred embodiments which do not limit the scope of the lighting-bearing tool tray kit; any equivalent change or improvement in shapes, structure or features without departing from spirit of the present disclosure should be incorporated in claims herein.

What is claimed is:

1. A lighting-bearing tool tray kit, comprising:
a tool tray on which a hand tool socket or tool part sockets at said tool tray's front and a back panel opposite to said tool tray's front are designed;
at least a lighting device which is installed on said tool tray and comprises at least a luminous element.

2. A lighting-bearing tool tray kit according to claim 1 wherein said lighting device is a long-shaped component.

3. A lighting-bearing tool tray kit according to claim 1 wherein said lighting device is laterally installed on said tool tray.

4. A lighting-bearing tool tray kit according to claim 1 wherein said tool tray develops a hanging hole on said back panel.

5. A lighting-bearing tool tray kit according to claim 1 wherein said tool tray joins a support component via pivots which is located on said back panel and rotationally detached from or attached to said tool tray.

6. A lighting-bearing tool tray kit according to claim 1 wherein said luminous elements are made of LEDs and said tool tray is provided with either a battery compartment in which batteries or rechargeable batteries are held or a power connector.

7. A lighting-bearing tool tray kit according to claim 1 wherein said lighting device comprises a flexible lamp arm with one end fixed on said tool tray and the other end comprising said luminous elements.

8. A lighting-bearing tool tray kit according to claim 1 wherein said tool tray further links a second tool tray via pivots on which at least a lighting device and at least a luminous element thereon are installed.

9. A lighting-bearing tool tray kit according to claim 1 wherein said lighting device joins said tool tray via pivots which drive said lighting device to rotate for a changed lighting direction.

10. A lighting-bearing tool tray kit according to claim 9 wherein said tool tray comprises sunken slots laterally in which said lighting device is held.

11. A lighting-bearing tool tray kit according to claim 9 wherein said lighting device can be separated from said pivots and installed on said tool tray's back panel for a changed lighting direction.

12. A lighting-bearing tool tray kit, comprising:
a tool tray on which a hand tool socket or tool part sockets at said tool tray's front and a back panel opposite to said tool tray's front are designed;
a second tool tray joining said tool tray via pivots ;
at least a lighting device installed on said tool tray and comprising at least a luminous element.

13. A lighting-bearing tool tray kit according to claim 12 wherein said lighting device is a long-shaped component.

14. A lighting-bearing tool tray kit according to claim 12 wherein said second tool tray is provided with at least a lighting device on which at least a luminous element is installed.

15. A lighting-bearing tool tray kit according to claim 12 wherein said tool tray joins a support component via pivots which is located on said back panel and said lighting device on said tool tray comprises a flexible lamp arm with one end fixed on said tool tray and the other end comprising said luminous elements.

16. A lighting-bearing tool tray kit according to claim 12 wherein said lighting device joins said tool tray via pivots for a changed lighting direction.

17. A lighting-bearing tool tray kit according to claim 12 wherein said lighting device is installed on said tool tray via said pivots.

18. A lighting-bearing tool tray kit according to claim 16 wherein said pivots rotationally drive said lighting device for a changed lighting direction.

19. A lighting-bearing tool tray kit according to claim 16 wherein said lighting device can be separated from said pivots and installed on said tool tray's back panel for a changed lighting direction.

20. A lighting-bearing tool tray kit according to claim 16 wherein said tool tray comprises sunken slots laterally in which said lighting device is held.
